(19) United States
(12) Patent Application Publication
(10) Pub. No.: US 2009/0083915 A1
(43) Pub. Date: Apr. 2, 2009

(54) REINFORCED FLEXIBLE CABLE FOR DRAIN CLEANING MACHINE

(76) Inventors: Dennis Cicchelli, Livonia, MI (US); Warren Giesin, Allen Park, MI (US)

Correspondence Address: Masco Corporation, 21001 Van Born Road, Taylor, MI, 48480, US

(21) Appl. No.: 11/865,223

(22) Filed: Oct. 1, 2007

(51) Int. Cl. B08B 9/02; A47L 25/00

(52) U.S. Cl. 15/3; 15/104.33

(57) ABSTRACT

A plumbers snake with a hollow outer body and an inner core which floats within the outer body.

### BACKGROUND OF THE INVENTION

The present invention relates to a drain cleaning machine, and more particularly to a snake therefore.

Conventional drum type drain cleaning machines typically include a frame structure supporting a rotatable snake drum and a drive motor arrangement for rotating the drum. The frame structure also supports a snake feeding arrangement by which the snake is axially displaced relative to the rotating drum during use of the machine. The snake coiled within the rotatable drum is displaced by the feeding arrangement and inserted into a pipe or drain to be cleaned. Rotation of the drum rotates the snake to achieve such cleaning.

A common type of plumbers snake comprises an elongated coil spring formed of hard drawn wire. The spring is wound tightly generally in a left hand direction so that the coils are in close proximity and resist unwinding when the snake is rotated in a right hand direction within a waste pipe or the like to clear obstructions therein. Under certain operating conditions, these types of springs prove to be too flexible and therefore certain manufacturers provide a metal core to stiffen and strengthen the snake. This latter type of snake may be difficult to use in many applications such as around 90 degree elbows and traps since the core may reduce flexibility. Additionally, such snakes may tend to kink during operation.

Accordingly, it is desirable to provide a plumbers snake of optimum rigidity without sacrificing flexibility.

### SUMMARY OF THE INVENTION

A plumbers snake according to an exemplary aspect of the present invention includes a hollow outer body coiled in a first direction and an inner core which floats within the outer body, the inner core having a multiple of strands which lay in a direction different than the first direction. The inner core defines an outer diameter which displaces between approximately between 91 percent and 94 percent (91%-94%) of an inner diameter of the hollow outer body.

### BRIEF DESCRIPTION OF THE DRAWINGS

The various features and advantages of this invention will become apparent to those skilled in the art from the following detailed description of the currently disclosed embodiment. The drawings that accompany the detailed description can be briefly described as follows:

FIG. 1 is a general perspective view of a drain cleaning machine having a reinforced flexible cable according to the present invention;

FIG. 2 is a longitudinal partial sectional view of a snake; and

FIG. 3 is a lateral sectional view of the snake of FIG. 2 taken along line 3-3.

### DETAILED DESCRIPTION OF THE DISCLOSED EMBODIMENT

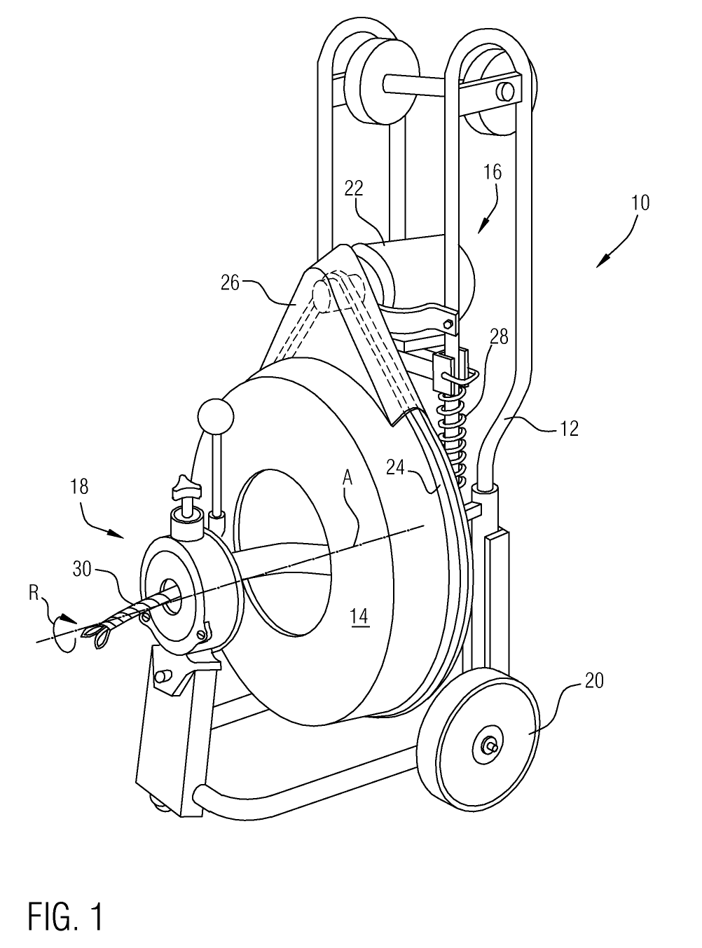

FIG. 1 illustrates a general perspective view of a portable drain cleaning machine 10 including a wheeled support frame assembly 12 which supports a rotatable snake drum 14, a drum drive assembly 16, and a snake feeding mechanism 18. Support frame assembly 12 is provided with at least one pair of wheels 20 such that the machine 10 is supported for rolling movement from one location to another.

The drum drive assembly 16 may include an electric motor 22 which drives a drive belt 24. The drive belt 24 extends from the motor 22 and about the perimeter of the drum 14. A removable cover 26 provides protection for the engagement between the belt 24 and motor 22. The motor 22 is mounted upon a biasing arrangement 28 which minimizes slack in the drive belt 24 and compensates for components which may be out of alignment while allowing removal of the belt 24. It should be understood that although the belt is illustrated about the perimeter of the drum in the disclosed embodiment, other drive arrangements will also benefit from the present invention.

The drum 14 contains a flexible plumbers snake 30 which extends outwardly through the feed assembly 18. The feed assembly 18 displaces the snake 30 inwardly and outwardly relative to the drum 14 during rotation of the drum 14. Rotation of the drive belt 24 rotates the drum 14 about an axis of rotation A in a first direction (illustrated by arrow R) to extend the snake from the drum 14. Rotation in an opposite direction (illustrated by arrow L) generally retracts the plumbers snake 30. It should be understood that the reverse is also applicable.

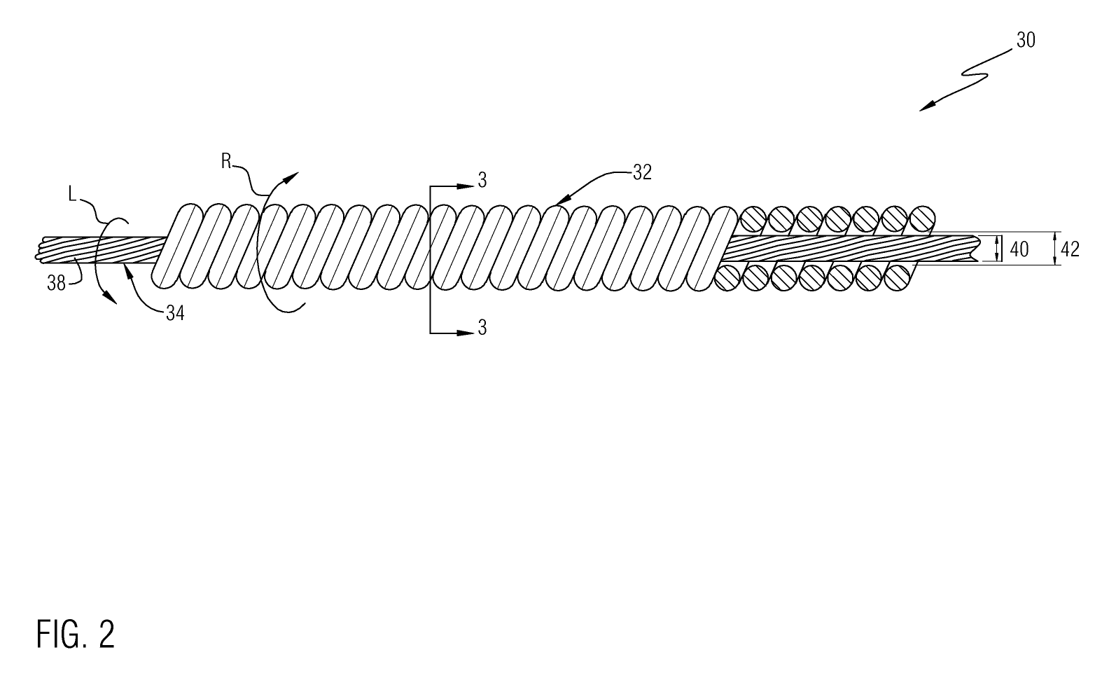

Referring to FIG. 2, the plumbers snake 30 generally includes a hollow outer body 32 and an inner core 34 which floats within the outer body 32. It should be understood that various materials, similar and dissimilar may be utilized for the inner core 34 and the outer body 32.

In one non-limiting embodiment, the hollow outer body 32 is formed of a length of, for example, a helically coiled spring steel wire, the turns 36 of which are coiled in the first direction. It should be understood that the turns 36 may be in contact or provide an axially spaced relationship. The turns 36 are coiled in the same direction (arrow R) in which rotation of the drum 14 (illustrated by arrow R) extends the snake 30 from the drum 14 so as to essentially tighten the coils.

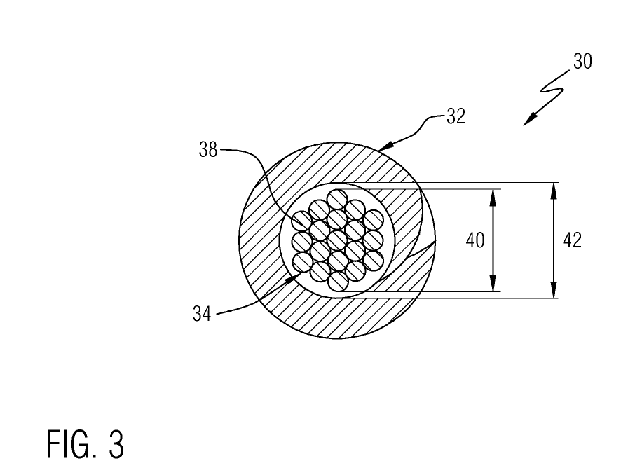

The inner core 34 is formed of a wire cable, the strands 38 (FIG. 3) of which lay in a direction opposite (arrow L) the turns 36 of the hollow outer body 32. In one non-limiting embodiment, the inner core 34 includes nineteen (19) strands 38 which lay in the direction in which rotation of the drum 14 retracts the snake 30 into the drum 14. It should be understood that any number of strands may be utilized.

The inner core 34 defines an outer diameter 40 which displaces more than 91 percent and less than 94 percent (91%-94%) of an inner diameter 42 of the hollow outer body 32 (also illustrated in FIG. 3). That is, the spacing allows the inner core 34 to essentially float within the hollow outer body 32, yet allows engagement therewith to provide cooperative interaction.

The cooperative interaction between the hollow outer body 32 and the inner core 34 serves not only to lend rigidity to the snake 30 but also serves to support the hollow outer body 32 on the inner core 34 when torque is applied to the hollow outer body 32. The opposite lay of the hollow outer body 32 and the inner core 34 transfers torque to lend rigidity and strength to the snake 30, yet the clearance therebetween facilitates bending of the snake 30 through pipe corners and the like. Furthermore, should the hollow outer body 32 break under torque, the inner core 34 will still allow extraction of the snake 30.

It should be understood that relative positional terms such as “forward,” “aft,” “upper,” “lower,” “above,” “below,” and the like are with reference to the normal operational attitude of the vehicle and should not be considered otherwise limiting.

It should be understood that although a particular component arrangement is disclosed in the illustrated embodiment, other arrangements will benefit from the instant invention.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The disclosed embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A plumbers snake comprising:
a hollow outer body coiled in a first direction; and
an inner core which floats within said outer body, said inner core having a multiple of strands which lay in a direction different than said first direction.

2. The plumbers snake as recited in claim 1, wherein said hollow outer body is helically coiled.

3. The plumbers snake as recited in claim 1, wherein said first direction is the same direction of a drum axis of rotation to extend said snake.

4. The plumbers snake as recited in claim 1, wherein said inner core defines an outer diameter which displaces between approximately between 91 percent and 94 percent (91%-94%) of an inner diameter of said hollow outer body.

5. The plumbers snake as recited in claim 1, wherein said inner core includes nineteen strands.

6. A plumbers snake comprising:
a hollow outer body; and
an inner core which defines an outer diameter which displaces between approximately between 91 percent and 94 percent (91%-94%) of an inner diameter of said hollow outer body.

7. The plumbers snake as recited in claim 6, wherein said hollow outer body is helically coiled.

8. The plumbers snake as recited in claim 6, wherein said inner core floats within said hollow outer body.

9. A drain cleaning machine comprising:
a rotary drum, said rotary rotatable about a drum axis of rotation, said drum rotatable in a first direction to extend a plumbers snake, said plumbers snake comprising a hollow outer body coiled in said first direction and an inner core which floats within said outer body, said inner core having a multiple of strands which lay in a direction different than said first direction.

10. The drain cleaning machine as recited in claim 9, wherein said inner core defines an outer diameter which displaces between approximately between 91 percent and 94 percent (91%-94%) of an inner diameter of said hollow outer body.
